(19) United States
(12) Patent Application Publication
(10) Pub. No.: US 2004/0262210 A1
(43) Pub. Date: Dec. 30, 2004

(54) System and method for capturing and positioning particles

(76) Inventors: Robert M. Westervelt, Cambridge, MA (US); Chungsok Lee, Pasadena, CA (US); Hakho Lee, Cambridge, MA (US)

Correspondence Address: Gauthier & Connors LLP, Suite 3300, 225 Franklin Street, Boston, MA, 02110, US

(21) Appl. No.: 10/837,787

(22) Filed: May 3, 2004

Related U.S. Application Data
(63) Continuation of application No. PCT/US02/36280, filed on Nov. 5, 2002.
(60) Provisional application No. 60/338,236, filed on Nov. 5, 2001.

(51) Int. Cl. B03C 1/02

(52) U.S. Cl. 210/222; 210/695

(57) ABSTRACT

A micro-electromagnet matrix captures and controls the movement of particles with nanoscale resolution. The micro-electromagnet matrix includes multiple layers of microconductors, each layer of microconductors being orthogonal to an adjacent layer or microconductors. The layers of microconductors are formed on a substrate and have insulating layers therebetween. The field patterns produced by the micro-electromagnet matrix enable precise manipulation of particles. The micro-electro-magnet matrix produces single or multiple independent field peaks in the magnetic field that are used to trap, move, or rotate the particles. The micro-electromagnet matrix also produces electromagnetic fields to probe and detect particles.

### CROSS-REFERENCE TO RELATED PROVISIONAL APPLICATION

The present patent application claims priority under 35 U.S.C. §119 from U.S. Provisional Patent Application Ser. No. 60/338,236 filed on Nov. 5, 2001. The entire contents of U.S. Provisional Patent Application Ser. No. 60/338,236 filed on Nov. 5, 2001 are hereby incorporated by reference.

### FIELD OF THE PRESENT INVENTION

The present invention is directed to controlling the position of nanoscale objects. More specifically, the present invention is directed to the generation of magnetic or electric fields that are used to trap, move, rotate, probe, detect, study, manipulate, and/or magnetic resonance image particles with nanoscale resolution.

### BACKGROUND OF THE PRESENT INVENTION

Interests in study and manipulation of nanoscale magnetic particles or nanoscale semiconductor particles have grown significantly with the advances in particle synthesis. Because of their small size, these particles show quantum characteristics even at room temperature, which have been observed either by using optical methods (photoluminescence) or by measuring electrical conductance (Coulomb blockade). However, the precise spatial control of these particles is in still incipient stage compared to the development of nanoparticle synthesis.

For example, magnetic tweezers have been conventionally used to trap small particles for study and manipulation; e.g., magnetic tweezers have been used in biophysics labs to study and manipulate DNA. Typically, a DNA string attached to a magnetic bead is manipulated by an external magnet. Using magnetic tweezers provides precise measurement of magnetic bead motion. However, conventional magnetic tweezers fail to provide individual control of multiple magnetic beads because conventional magnetic beads can only control one bead or group of beads, not many beads individually

Scanning probe electromagnet tweezers have also been used conventionally to manipulate micron sized magnetic particles by integrating a microcoil on a soft ferromagnetic microtip. The tip produces the magnetic field gradient and magnetic particles follow the motion of the tip. The conventional scanning probe electromagnet tweezer can manipulate one particle with high resolution. However, since the scanning probe electromagnet tip is cone shaped and it is attached to a larger cantilever, it is very difficult to operate two or more scanning probe electromagnet tweezers simultaneously with the tips close together.

Optical tweezers, using a focused laser beam, have also been conventionally used to trap and move particles suspended in fluid. The focused laser beam of an optical tweezer induces electrical dipole moments in particles, which in turn interact with the electric field of the laser, generating forces on the particles toward the focal point of the laser beam. The trapped particles, then, can be moved by moving the position of the laser beam. Due to this flexibility, optical tweezers have been widely used in various fields including atomic physics and biology as a way of micromanipulating small objects. However, the number of traps that can be simultaneously formed and independently controlled is limited since each trap needs a focused laser beam with the appropriate scanning instruments.

Furthermore, dielectrophoresis has also been conventionally used to trap particles suspended in fluid. Dielectrophoresis is the translation motion of neutral particles caused by polarization effects in a non-uniform electric field. Depending on the differences of the dielectric constants of neutral particles and their surrounding medium, net forces can be exerted to the particles either in the direction of higher electric field intensity or lower electric field intensity. This behavior is utilized to trap neutral particles in fluids by generating non-uniform electric fields from a set of fixed electrodes. The dielectrophoresis traps, which have been realized so far, are good at trapping many neutral particles simultaneously but their capabilities of moving trapped particles are still limited.

Moreover, the following patents disclose various types of prior art magnetic particle separators.

U.S. Pat. No. 5,053,344 to Zborowski et al. discloses a magnetic field separation system having a flow chamber comprised of first and second optically transparent slides mounted so as to define a generally planar fluid pathway. The flow chamber is oriented to promote fluid flow therethrough by a combination of gravitational and capillary action. Permanent magnets constitute a magnet means for separating sensitized particles in a biological fluid.

U.S. Pat. No. 5,123,901 to Carew discloses a method for removing or separating pathogenic or toxic agents from body fluids in which the pathogenic or toxic agent is flowed into a mixing coil along with a plurality of paramagnetic beads for marking the pathogenic agent. The mixture is then passed through a magnetic separator having a separation chamber. The separator is provided with a graded magnetic field along the length of the separation chamber. The magnetic field causes the paramagnetic beads with bound pathogenic agent to adhere magnetically to the wall of the separator.

U.S. Pat. No. 5,655,665 to Allen et al. discloses a fully integrated micro-machined magnetic particle manipulator and separator. The magnetic particle separator comprises a fluid channel and two meander-type integrated inductive components located on each side of the fluid channel. The ends of the magnetic cores of the inductive components are disposed adjacent to the fluid channel. The conductors of the inductive components are electrically coupled to bonding pads that, in operation, receive a DC voltage that results in an electric current being supplied to the conductors of the inductive component. During operation, suspended magnetic particles are subjected to the magnetic field generated by the inductive components and field gradients generated from the component pole geometries and thus are forced to move from the suspension to the surface of the electromagnet poles while the magnetic field is “ON.” Since the device is composed of a fluid flow channel and inductive components on each side of the channel, when currents flow, the inductive components produce magnetic fields, and magnetic particles are clumped onto the electromagnet poles. This produces a single location trap.

Micro-electromagnets have conventionally been used to separate or trap ultra-cold atoms passing through a vacuum, such as Cesium atoms, as described in an article in Applied Physics Letters, volume 72, number 22 of Jun. 1, 1998, entitled “Micro-electromagnets for Atom Manipulation,” by M. Drndic et al. This article discloses that the micro-electromagnets consist of a planar micron-scale serpentine pattern of Au current-carrying wires on a sapphire substrate fabricated using lithography and electroplating. The micro-electromagnets are used to trap ultra-cold Cesium atoms in a vacuum for further study and probing.

Lastly, manipulation of magnetic microbeads in suspension has been described in an article in Applied Physics Letters, volume 78, number 12 of Mar. 1, 2001, entitled “Manipulation of Magnetic Microbeads in Suspension using Micromagnetic Systems Fabricated with Soft Lithography,” by Tao Deng et al. This article describes a micromagnetic system as shown in FIGS. 1-5. As shown in FIG. 1, two substantially parallel serpentine wires 1 and 3 are placed under a solution having suspended superparamagnetic beads 11. In FIG. 1, wire 3 has a current flowing therethrough so as to trap a bead 11 in magnetic field location 8. In FIG. 2, wire 1 has a current flowing therethrough so as to move the trapped bead 11 of FIG. 1 from magnetic field location 8 to magnetic field location 6. In FIG. 3, wire 3 has a current flowing therethrough, in a direction opposite of FIG. 1, so as to move the trapped bead 11 from magnetic field location 6 to magnetic field location 9. In FIG. 4, wire 1 has a current flowing therethrough, in a direction opposite of FIG. 2, so as to move the trapped bead 11 from magnetic field location 9 to magnetic field location 7. Lastly, in FIG. 5, wire 3 has a current flowing therethrough, in a same direction of FIG. 1, so as to move the trapped bead 11 from magnetic field location 7 to magnetic field location 10.

As illustrated in FIGS. 1-5, this conventional device can capture and move magnetic beads in a one-dimensional zigzag path. The conventional device requires an external magnetic field, and the particles move in steps of several hundred microns. However, the conventional device of FIGS. 1-5 cannot independently move separate groups of magnetic particles. This conventional device moves all groups of particles at the same time in steps along a line. Moreover, the movement of the particles is discrete; not continuous or smooth.

In all the conventional devices and methods described above, small particles can be separated or trapped in a liquid, fluid, or other type of environment using magnetic or electric fields; however, these conventional devices cannot produce a number of peaks in magnetic or electric field amplitude that can be independently controlled at different positions with nanoscale resolution. Moreover, these conventional devices cannot provide movement of particles suspended in a fluid with nanoscale resolution at room temperature.

Therefore, it is desirable to provide a system that overcomes the various drawbacks of the prior art devices. More specifically, it is desirable to provide a system that includes micro-electromagnets or microelectrodes, which are fully integrated on a single chip with no scanning components. It is further desirable to provide a system that can produce a large number of magnetic field peaks simultaneously or a large number of electric field peaks simultaneously and move the produced magnetic or electric field peaks independently. It is also desirable to provide a system that individually controls the manipulation of the magnetic or non-magnetic particles. Moreover, it is desirable to provide a system that moves, manipulates, or rotates the magnetic particles with nanoscale resolution. Lastly, it is desirable to provide a system that moves, manipulates, or rotates the non-magnetic particles with nanoscale resolution.

### SUMMARY OF THE PRESENT INVENTION

A first aspect of the present invention is a microstructure system for capturing and positioning magnetic particles. The microstructure system includes a substrate layer; a first set of microconductors formed upon the substrate layer; a first insulating layer formed upon the first set of microconductors; a second set of microconductors formed upon the first insulating layer; and a current generator circuit, having a plurality of individually controllable current sources, to generate an independent variable current in each microconductor from the first and second set of microconductors so as to generate a peak in its magnitude, with the location of the magnetic field peak being established with nanoscale resolution.

A second aspect of the present invention is a microstructure system for capturing and positioning magnetic particles. The microstructure system includes a substrate layer; a first serpentine-shaped microconductor formed upon the substrate layer; a first insulating layer formed upon the first serpentine-shaped microconductor; a second serpentine-shaped microconductor formed upon the first insulating layer; and a current generator circuit to generate variable independent currents along the first and second serpentine-shaped microconductors so as to generate a magnetic field pattern having a plurality of magnetic field peaks.

A third aspect of the present invention is a microstructure system for capturing and positioning particles. The microstructure system includes a substrate layer; a matrix of microelectrodes formed upon the substrate layer; an insulating layer formed upon the matrix of microelectrodes; and a voltage generator circuit, having a plurality of individually controllable voltage sources, to generate an independent variable voltage in each microelectrode so as to generate a peak in its magnitude, with the location of the electric field peak being established with nanoscale resolution.

A fourth aspect of the present invention is a method for capturing and positioning magnetic particles. The method provides a fluid upon a surface having magnetic particles therein; generates a plurality of independent magnetic field peaks; captures a magnetic particle with one of the generated magnetic field peaks; and changes a location of one of the magnetic field peaks to move the captured magnetic particle with nanoscale resolution.

A fifth aspect of the present invention is a method for capturing and positioning particles. The method provides a fluid upon a surface having particles therein; generates a plurality of independent electric field peaks; captures a particle with one of the generated electric field peaks; and changes a location of one of the electric field peaks to move the captured particle with nanoscale resolution.

A sixth aspect of the present invention is a method for capturing and positioning multiple sets of magnetic particles. The method provides a fluid upon a surface having magnetic particles therein; generates a plurality of independent magnetic field peaks; captures a plurality of magnetic particles with each of the generated independent magnetic field peaks; and changes, substantially simultaneously, locations of the plurality of independent magnetic field peaks to move, independently, a plurality of the captured set of magnetic particles with nanoscale resolution.

A seventh aspect of the present invention is a method for capturing and positioning multiple sets of particles. The method provides a fluid upon a surface having particles therein; generates a plurality of independent electric field peaks; captures a plurality of particles with each of the generated independent electric field peaks; and changes, substantially simultaneously, locations of the plurality of independent electric field peaks to move independently, a plurality of the captured set of particles with nanoscale resolution.

An eighth aspect of the present invention is a system for capturing and positioning multiple sets of magnetic particles. The system includes a micro-electromagnetic matrix having a plurality of individually addressable microconductors and a plurality of controllable current sources, each individually addressable microconductor having a controllable current source associated therewith. Each controllable current source provides a current to the associated individually addressable microconductor to generate a magnetic field peak. The magnetic field peak has a location that can be moved continuously.

A ninth aspect of the present invention is a system for capturing and positioning multiple sets of particles. The system includes a microelectrode matrix having a plurality of individually addressable electrodes and a plurality of controllable voltages sources. Each individually addressable electrode has a controllable voltage source associated therewith. Each controllable voltage source provides a voltage to the associated individually addressable microelectrode to generate an electric field peak. The electric field peak has a location that can be moved continuously.

A tenth aspect of the present invention is an integrated circuit for capturing and positioning magnetic particles. The integrated circuit includes an access window; a plurality of individually addressable microconductors located in the access window, the plurality of individually addressable microconductors having different directions and forming in a matrix; and a micro-controller to control an amount of current being applied to each of the individually addressable microconductors.

An eleventh aspect of the present invention is an integrated circuit for capturing and positioning particles. The integrated circuit includes an access window; a plurality of individually addressable microelectrodes located in the access window, the plurality of individually addressable microelectrodes forming in a matrix; and a micro-controller to control an amount of voltage being applied to each of the individually addressable microelectrodes.

A twelfth aspect of the present invention is a microstructure system for capturing and positioning magnetic particles. The microstructure includes a substrate layer; a plurality of layers of microconductors formed upon the substrate layer; a plurality of insulating layers, an insulating layer being formed between each layer of microconductors; and a current generator circuit, having a plurality of individually controllable current sources, to generate an independent variable current in each microconductor so as to generate a magnetic field having a peak in its magnitude, with the location of the magnetic field peak being established with nanoscale resolution.

A thirteenth aspect of the present invention is a microstructure system for applying radio frequency fields to a particle. The microstructure includes a substrate layer; a plurality of layers of microconductors formed upon the substrate layer; a plurality of insulating layers, an insulating layer being formed between each layer of microconductors; and a current generator circuit, having a plurality of individually controllable current sources, to generate an independent alternating current in each microconductor so as to generate a radio frequency electromagnetic field to a particle.

A fourteenth aspect of the present invention is a microstructure system for capturing and positioning particles. The microstructure system includes a substrate layer; a first set of microconductors formed upon the substrate layer; a first insulating layer formed upon the first set of microconductors; a second set of microconductors formed upon the first insulating layer; and a voltage generator circuit, having a plurality of individually controllable voltage sources, to generate an independent variable voltage on each microconductor to ground from the first and second set of microconductors so as to generate a peak in its magnitude, with the location of the electric field peak being established with nanoscale resolution.

A fifteenth aspect of the present invention is a microstructure system for capturing and positioning particles. The microstructure system includes a substrate layer; a first set of microconductors formed upon the substrate layer; a first insulating layer formed upon the first set of microconductors; a second set of microconductors formed upon the first insulating layer; a voltage generator circuit, having a plurality of individually controllable voltage sources, to generate an independent variable voltage on each microconductor to ground from the first and second set of microconductors so as to generate a peak in its magnitude, with the location of the electric field peak being established with nanoscale resolution; and a current generator circuit, having a plurality of individually controllable current sources, to generate an independent variable current in each microconductor from the first and second set of microconductors so as to generate a peak in its magnitude, with the location of the magnetic field peak being established with nanoscale resolution.

A sixteenth aspect of the present invention is a microstructure system for capturing and positioning particles. The microstructure system includes a substrate layer; a first serpentine-shaped microconductor formed upon the substrate layer; a first insulating layer formed upon the first serpentine-shaped microconductor; a second serpentine-shaped microconductor formed upon the first insulating layer; and a voltage generator circuit to generate variable independent voltages on the first and second serpentine-shaped microconductors so as to generate an electric field pattern having a plurality of electric field peaks.

A seventeenth aspect of the present invention is a microstructure system for capturing and positioning particles. The microstructure system includes a substrate layer; a first serpentine-shaped microconductor formed upon the substrate layer; a first insulating layer formed upon the first serpentine-shaped microconductor; a second serpentine-shaped microconductor formed upon the first insulating layer, a voltage generator circuit to generate variable independent voltages on the first and second serpentine-shaped microconductors so as to generate an electric field pattern having a plurality of electric field peaks; and a current generator circuit to generate variable independent currents along the first and second serpentine-shaped microconductors so as to generate a magnetic field pattern having a plurality of magnetic field peaks.

An eighteenth aspect of the present invention is a system for capturing and positioning multiple sets of particles. The system includes a micro-electromagnetic matrix having a plurality of individually addressable microconductors and a plurality of controllable voltage sources, each individually addressable microconductor having a controllable voltage source associated therewith, each controllable voltage source providing a voltage to the associated individually addressable microconductor to generate an electric field peak, the electric field peak having a location that can be moved continuously.

A nineteenth aspect of the present invention is a system for capturing and positioning multiple sets of particles. The system includes a micro-electromagnetic matrix having a plurality of individually addressable microconductors; a plurality of controllable current sources, each individually addressable microconductor having a controllable current source associated therewith, each controllable current source providing a current to the associated individually addressable microconductor to generate a magnetic field peak, the magnetic field peak having a location that can be moved continuously; and a plurality of controllable voltage sources, each individually addressable microconductor having a controllable voltage source associated therewith, each controllable voltage source providing a voltage to the associated individually addressable microconductor to generate an electric field peak, the electric field peak having a location that can be moved continuously.

A twentieth aspect of the present invention is an integrated circuit for capturing and positioning particles. The integrated circuit includes an access window; a plurality of individually addressable microconductors located in said access window, the plurality of individually addressable microconductors having different directions and forming in a matrix; a plurality of controllable current sources, each individually addressable microconductor having a controllable current source associated therewith, each controllable current source providing a current to the associated individually addressable microconductor to generate a magnetic field peak, the magnetic field peak having a location that can be moved continuously; and a plurality of controllable voltage sources, each individually addressable microconductor having a controllable voltage source associated therewith, each controllable voltage source providing a voltage to the associated individually addressable microconductor to generate an electric field peak, the electric field peak having a location that can be moved continuously.

A further aspect of the present invention is an integrated circuit for capturing and positioning particles. The integrated circuit includes an access window; a plurality of individually addressable microconductors located in the access window, the plurality of individually addressable microconductors having different directions and forming in a matrix; and a plurality of controllable current sources, each individually addressable microconductor having a controllable current source associated therewith, each controllable current source providing a current to the associated individually addressable microconductor to generate a magnetic field peak, the magnetic field peak having a location that can be moved continuously.

A still further aspect of the present invention is an integrated circuit for capturing and positioning particles. The integrated circuit includes an access window; a plurality of individually addressable microconductors located in the access window, the plurality of individually addressable microconductors having different directions and forming in a matrix; and a plurality of controllable voltage sources, each individually addressable microconductor having a controllable voltage source associated therewith, each controllable voltage source providing a voltage to the associated individually addressable microconductor to generate an electric field peak, the electric field peak having a location that can be moved continuously.

Another aspect of the present invention is an integrated circuit for capturing and positioning particles. The integrated circuit includes an access window; a plurality of individually addressable microconductors located in the access window, the plurality of individually addressable microconductors having different directions and forming in a matrix; and a micro-controller to control an amount of voltage being applied to each of the individually addressable microconductors.

A further aspect of the present invention is an integrated circuit for capturing and positioning particles. The integrated circuit includes an access window; a plurality of individually addressable microconductors located in the access window, the plurality of individually addressable microconductors having different directions and forming in a matrix; and a micro-controller to control an amount of current or voltage being applied to each of the individually addressable microconductors.

A still further aspect of the present invention is a microstructure system for capturing and positioning particles. The microstructure system includes a substrate layer; a plurality of layers of microconductors formed upon the substrate layer; a plurality of insulating layers, an insulating layer being formed between each layer of microconductors; and a voltage generator circuit, having a plurality of individually controllable voltage sources, to generate an independent variable voltage on each microconductor so as to generate an electric field having a peak in its magnitude, with the location of the electric field peak being established with nanoscale resolution.

Another aspect of the present invention is a microstructure system for capturing and positioning particles. The microstructure system includes a substrate layer; a plurality of layers of microconductors formed upon the substrate layer; a plurality of insulating layers, an insulating layer being formed between each layer of microconductors; a current generator circuit, having a plurality of individually controllable current sources, to generate an independent variable current in each microconductor so as to generate a magnetic field having a peak in its magnitude, with the location of the magnetic field peak being established with nanoscale resolution; and a voltage generator circuit, having a plurality of individually controllable voltage sources, to generate an independent variable voltage on each microconductor so as to generate an electric field having a peak in its magnitude, with the location of the electric field peak being established with nanoscale resolution.

### BRIEF DESCRIPTION OF THE DRAWINGS

The present invention may take form in various components and arrangements of components, and in various steps and arrangements of steps. The drawings are only for purposes of illustrating a preferred embodiment and are not to be construed as limiting the present invention, wherein:

FIGS. 1-5 illustrate the moving of a magnetic particle using a conventional device;

FIG. 6 illustrates a fabricated single ring trap according to the concepts of the present invention;

FIG. 7 illustrates a fabricated micro-electromagnetic array according to the concepts of the present invention;

FIG. 8 illustrates the wiring convention for the micro-electromagnetic array of FIG. 7;

FIG. 9 illustrates a fabricated micro-electromagnetic matrix according to the concepts of the present invention;

FIG. 10 illustrates the wiring convention for the micro-electromagnetic matrix of FIG. 9;

FIG. 11 illustrates a schematic of a micro-electromagnetic matrix according to the concepts of the present invention;

FIG. 12 is a topographical representation of a magnetic field peak produced according to the concepts of the present invention;

FIG. 13 illustrates a microelectrode matrix according to the concepts of the present invention;

FIG. 14 illustrates the moving of particles using a micro-electromagnetic matrix according to the concepts of the present invention;

FIG. 15 illustrates the moving of magnetic field peak used to move the particles as shown in FIG. 14 according to the concepts of the present invention;

FIG. 16 illustrates a cross-sectioning of the magnetic field peak used in the illustration of FIG. 15;

FIG. 17 illustrates an example of transporting of a particle according to the concepts of the present invention;

FIG. 18 illustrates an example of converging of two particles according to the concepts of the present invention;

FIG. 19 illustrates an example of splitting up a group of particles according to the concepts of the present invention;

FIG. 20 illustrates the individual addressability of individual microconductors in a micro-electromagnetic matrix according to the concepts of the present invention;

FIG. 21 illustrates conceptually the use of two currents to spin a particle according to the concepts of the present invention;

FIG. 22 is a closer view of a fabricated micro-electromagnetic matrix according to the concepts of the present invention;

FIGS. 23 through 27 illustrate a fabrication process for a micro-electromagnetic matrix according to the concepts of the present invention;

FIG. 28 illustrates one embodiment of a particle manipulation system according to the concepts of the present invention;

FIG. 29 illustrates another embodiment of a particle manipulation system according to the concepts of the present invention;

FIG. 30 illustrates one embodiment of a particle manipulation integrated circuit chip according to the concepts of the present invention; and

FIG. 31 illustrates another embodiment of a particle manipulation integrated circuit chip according to the concepts of the present invention.

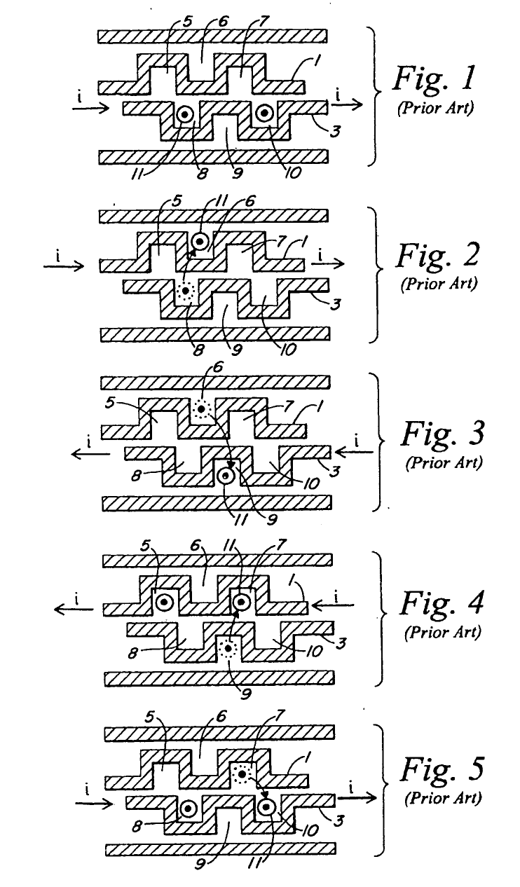

### DETAILED DESCRIPTION OF THE PRESENT INVENTION

The present invention will be described in connection with specific embodiments; however, it will be understood that there is no intent to limit the present invention to the embodiments described herein. On the contrary, the intent is to cover all alternatives, modifications, and equivalents as may be included within the spirit and scope of the present invention as defined by the appended claims.

For a general understanding of the present invention, reference is made to the drawings. In the drawings, like reference have been used throughout to designate identical or equivalent elements. It is also noted that the various drawings illustrating the present invention are not drawn to scale and that certain regions have been purposely drawn disproportionately so that the features and concepts of the present invention could be properly illustrated.

For the purposes of explaining the concepts of the present invention, the term, “particle,” will be used in describing an object being manipulated by the present invention. Particle, in this specification, refers to any organic or non-organic object, magnetic or non-magnetic object, or living organism that has a size in the range of approximately five nanometers to two hundred microns.

Moreover, for the purposes of explaining the concepts of the present invention, the term, “continuous,” will be used in describing the movement of the field peak by the present invention. Continuous, in this specification, refers to non-hopping, non-discrete, or non-step-type movement. In other words, continuous, in this specification, refers to a smooth movement of the location of the field peak.

As noted above, micromanipulation is helpful in the process of characterizing particles. However, the micromanipulation of these particles is crucial to construct desired, custom-made structures, which utilize the unique quantum characteristic of each particle. The present invention addresses both the micromanipulation of magnetic particles and non-magnetic particles through the use of generated magnetic field peaks or electric field peaks that have nanoscale resolution in their location, have enough strength to trap the particles at the relevant temperature, and can be moved continuously. Initially, the present invention will be described with respect to the micromanipulation of magnetic particles.

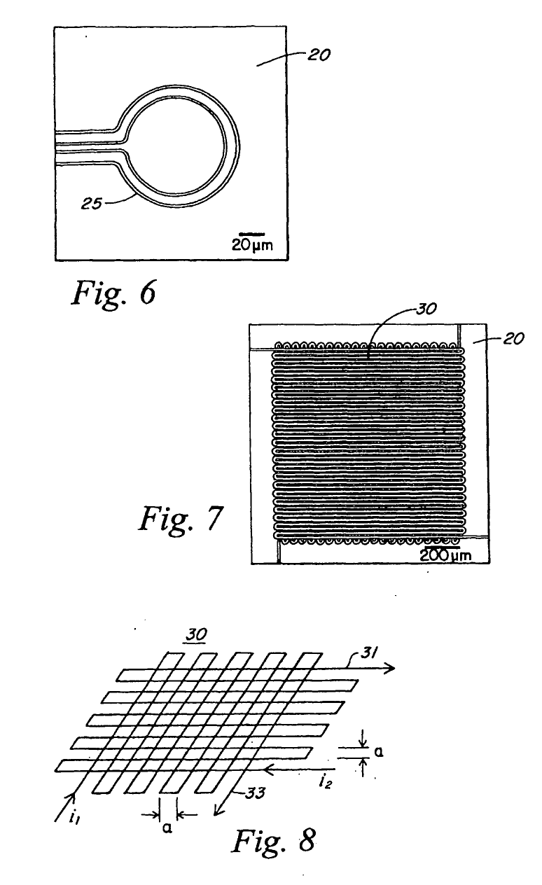

With respect to magnetic particles, the present invention provides microscopic control and manipulation of magnetic particles using a micro-electromagnetic matrix or a micro-electromagnet ring trap. As an example of microscopic control and manipulation of magnetic particles, the present invention provides a single circular ring trap, as illustrated in FIG. 6.

As shown in FIG. 6, a microconductor 25, preferably of Au, is fabricated upon a substrate 20 in the form of a ring. As current is passed through the microconductor 25, a magnetic field peak is produced in the center of the ring trap. If the ring trap of FIG. 6 is placed in close proximity to a fluid containing magnetic particles, the magnetic field produced by the current-carrying microconductor 25 will attract the magnetic particles in the fluid to maxima in the magnetic field magnitude so as to trap the magnetic particles in the fluid in the area of the ring.

FIG. 7 illustrates a micro-electromagnetic array according to the concepts of the present invention. As shown in FIG. 7, a micro-electromagnetic array 30 is fabricated upon a substrate 20. The micro-electromagnetic array 30, as specifically illustrated in FIG. 7, comprising at least two serpentine microconductors superimposed over each other in an orthogonal fashion. It is noted that the angle between the serpentine microconductors need not be orthogonal, but may be any angle between zero degrees and ninety degrees. FIG. 8 illustrates the actual wiring convention in more detail.

As shown in FIG. 8, one serpentine microconductor 31 is formed on a substrate. An insulating layer, not shown is overlays the serpentine microconductor 31. Upon the insulating layer, a serpentine microconductor 33 is formed. The serpentine microconductor 31 carries current i₂ while serpentine microconductor 33 carries current i₁. The current flowing through the serpentine microconductor 31 and the serpentine microconductor 33 create a magnetic field peak pattern such that trapped particles form a pattern that is substantially checkered board. It is further noted that the serpentine microconductor 31 may have a voltage v₂ thereon while serpentine microconductor 33 may have a voltage v₁. The voltages on the serpentine microconductor 31 and the serpentine microconductor 33 create an electric field peak pattern such that trapped particles form a pattern that is substantially checkered board.

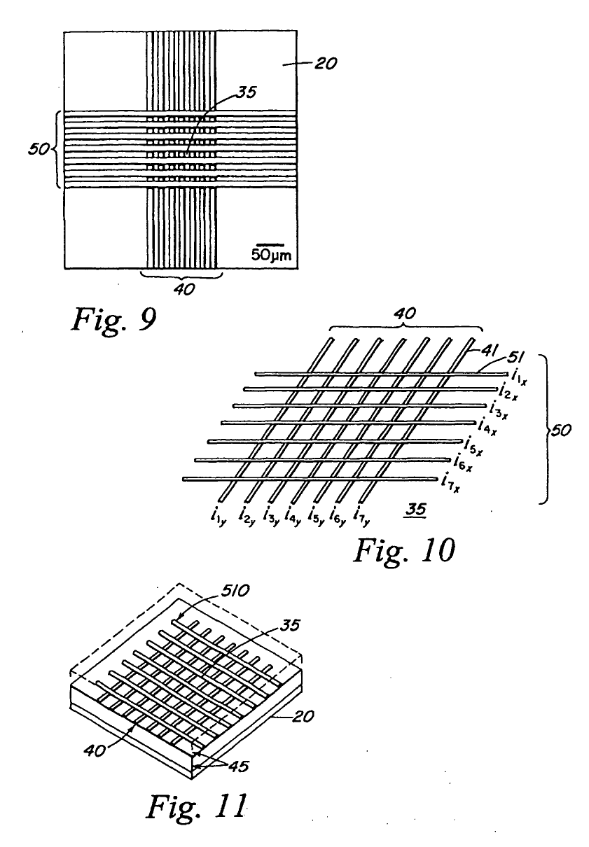

FIG. 9 illustrates a micro-electromagnetic matrix according to the concepts of the present invention. As shown in FIG. 9, a micro-electromagnetic matrix 35 is fabricated upon a substrate 20. The micro-electromagnetic matrix 35, as specifically illustrated in FIG. 9, comprises at least two sets or arrays of microconductors superimposed over each other in an orthogonal fashion.

It is noted that the angle between the sets of microconductors need not be orthogonal, but may be any angle between zero degrees and ninety degrees. It is further noted that microconductors of the micro-electromagnetic matrix 35 may be a collection of wires having different directions that are not necessarily orthogonal to each other. The plurality of microconductors in the micro-electromagnetic matrix 35 may form any type of regular polygonal shape within the micro-electromagnetic matrix, or the plurality of microconductors can be woven in many layers to create non-regular shapes in the micro-electromagnetic matrix. The micro-electromagnetic matrix merely comprises a collection of wires that when an independent current or voltage is applied in each microconductor, a magnetic or electric field peak is generated that is strong enough to manipulate the particles.

For example as shown in FIG. 10, the micro-electromagnetic matrix 35 comprises one set of microconductors 40, having individually addressable microconductors 41, positioned over a second set of microconductors 50, having individually addressable microconductors 51. As illustrated, the specific embodiment has seven individually addressable microconductors 41 and seven individually addressable microconductors 51. The seven individually addressable microconductors 41 carry currents i_{y1} through i_{y7}, while the seven individually addressable microconductors 51 carry currents iₓ₁ through iₓ₇ to generate a magnetic field for trapping and moving magnetic particles. It is noted that seven individually addressable microconductors 41 may have voltages v_{y1} through v_{y7} thereon, while the seven individually addressable microconductors 51 may have voltages vₓ₁ through vₓ₇ thereon to generate an electric field for trapping and moving particles.

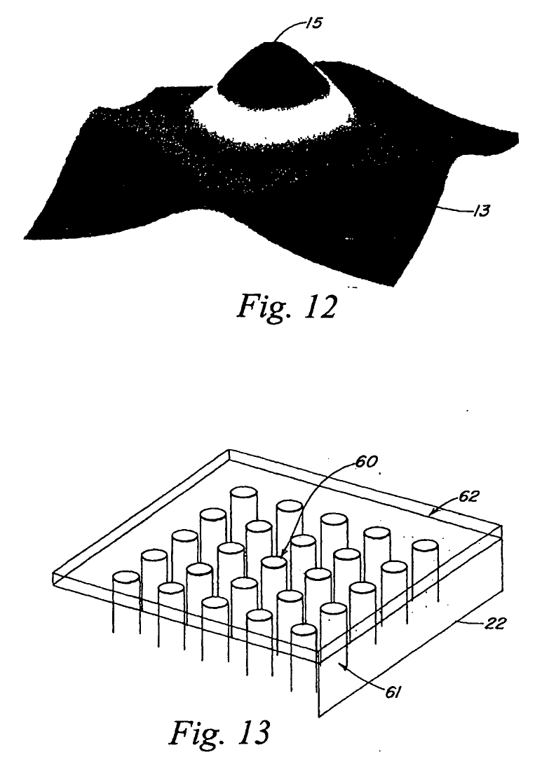

FIG. 12 illustrates a topographical profile of a typical magnetic field produced by the present invention. The magnetic field has a Gaussian distribution 13 with a magnetic field peak 15. The amplitude of magnetic field peak 15 of the magnetic field is proportional to the magnitude of the currents flowing through the individually addressable microconductors. Moreover, the characteristic of the magnetic field with respect to the magnetic field being constant or alternating depends upon the nature of the current flowing through individually addressable microconductors, direct or alternating current.

FIG. 11 shows a closer view of the fabrication of the micro-electromagnetic matrix of FIG. 9. As shown in FIG. 11, a micro-electromagnetic matrix 35 is made by forming a set of microconductors 410 upon a substrate 20, preferably a substrate comprising sapphire. Upon the set of microconductors 410, an insulating layer 45 is formed. On this first insulating layer 45, a set of microconductors 510 is formed. Upon the set of microconductors 510, a second insulating layer 45 is formed. In this specific illustrated example, the two sets or arrays of microconductors are superimposed over each other in an orthogonal fashion.

It is noted that the angle between the sets of microconductors need not be orthogonal, but may be any angle between zero degrees and ninety degrees. It is further noted that microconductors of the micro-electromagnetic matrix 35 may be a collection of wires having different directions that are not necessarily orthogonal to each other. The plurality of microconductors in the micro-electromagnetic matrix 35 may form any type of regular polygonal shape within the micro-electromagnetic matrix, or the plurality of microconductors can be woven in many layers to create non-regular shapes in the micro-electromagnetic matrix. The micro-electromagnetic matrix merely comprises a collection of wires that when an independent current or voltage is applied in each microconductor, a magnetic or electric field peak is generated that is strong enough to manipulate the particles.

By utilizing the micro-electromagnetic matrix of the present invention, a single magnetic field peak can be generated by applying certain the individual current levels in the microconductors. The currents flowing through the various microconductors generate a magnetic field having a local peak in its magnitude. This magnetic field peak can be used to effectively trap magnetic particles in a fluid or non-magnetic particles having a magnetic particle attached thereto in a fluid.

For trapping to occur, the magnetic field must be strong enough to move the particle. The strength of trapping can be estimated for ferromagnetic and paramagnetic particles. For a ferromagnetic particle with magnetic moment m=Nμ_{B}, where N is the number of Bohr magnetons, the potential energy is U=−mB=−Nμ_{B}B. The average kinetic energy of a particle due to thermal motion is K=(3/2)k_{B}T, where k_{B} is the Boltzmann constant. The particles will be attracted to field maxima, provided the absolute value of U is greater or equal to K The condition N≧((3/2)(k_{B}T/μ₂B)) determines the minimum magnetization of a ferromagnetic particle that can be trapped. For B=0.1 T, this gives N≧6700 at T=300 K, a magnetization corresponding to nanoscale particles. Nanoscale particles may become superparamagnetic. For a paramagnetic particle with magnetic moment m=(χB/μ₀)V, where χ is the magnetic susceptibility, V is the particle volume, and μ₀ is the permeability of free space, the potential energy is U=−mB=−(χB²/μ₀)V. The minimum size of a paramagnetic particle that can be trapped is V≧((3/2)(k_{B}Tμ₀/χB²)). It is noted that by utilizing the concepts of the present invention, this trapping can occur at room temperature.

The magnetic field peak can also be moved continuously over the matrix with spatial resolution less than the microconductor spacing by further individually adjusting the current levels in the microconductors. This enables the present invention to move the trapped particles continuously with nanoscale resolution. It is noted that by utilizing the concepts of the present invention that this nanoscale resolution continuous movement of the particles can occur at room temperature.

The determination of the actual individual current levels can be easily calculated using well-known least square optimization algorithms. In other words, the current directions for the various microconductors of a micro-electromagnetic matrix are known. Using this, a sample set of currents that could be applied is used to calculate the magnetic field profile wherein the profile includes information as to magnetic field peak location and magnetic field peak shape. If the calculated magnetic field profile doesn't correspond to a predetermined model magnetic field profile, the currents are adjusted or modified and a new magnetic field profile is determined. This process is repeated until a determined magnetic field profile corresponds to the predetermined model magnetic field profile.

As noted above, by utilizing the micro-electromagnetic matrix of the present invention, a single electric field peak can also be generated by applying certain the individual voltage levels on the microconductors. The voltages on the various microconductors generate an electric field having a local peak in its magnitude. This electric field peak can be used to effectively trap particles in a fluid. The electric field peak can also be moved continuously over the matrix with spatial resolution less than the microconductor spacing by further individually adjusting the voltage levels on the microconductors. This enables the present invention to move the trapped particles continuously with nanoscale resolution. It is noted that by utilizing the concepts of the present invention that this nanoscale resolution continuous movement of the particles can occur at room temperature.

The determination of the actual individual voltage levels can be easily calculated using well-known least square optimization algorithms. In other words, the voltages on the various microconductors of a micro-electromagnetic matrix are known. Using this, a sample set of voltages that could be applied is used to calculate the electric field profile wherein the profile includes information as to electric field peak location and electric field peak shape. If the calculated electric field profile doesn't correspond to a predetermined model electric field profile, the voltages are adjusted or modified and a new electric field profile is determined. This process is repeated until a determined electric field profile corresponds to the predetermined model electric field profile.

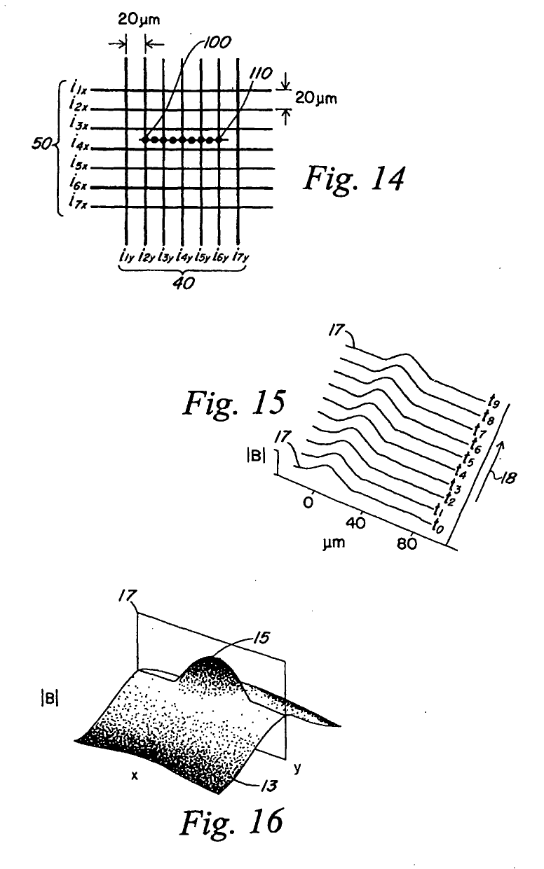

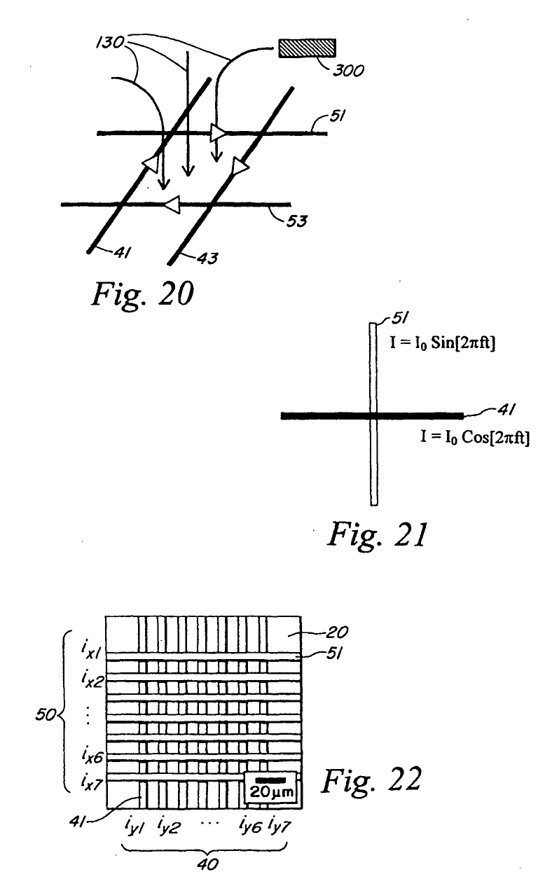

FIG. 14 shows the movement of a magnetic particle using the micro-electromagnetic matrix of the present invention. As shown in FIG. 14, a magnetic particle is moved from location 100 to location 110 by adjusting the current magnitudes of currents, i_{y1} through i_{y7} and iₓ₁ through iₓ₇, in the seven individually addressable microconductors 41 of microconductor set 40 and the seven individually addressable microconductors 51 of microconductor set 50, respectively. More specifically, as shown in FIG. 20, the current flowing through microconductors 41, 43, 51, and 53 as well as the other microconductors (not shown) on the micro-electromagnetic matrix, produces a magnetic field having magnetic field strength lines 130. The magnetic field strength lines 130 attract the magnetic particle 300 to a position representing the magnetic field peak. As the magnetic field peak moves in a continuous manner, the magnetic particle 300 will be drawn to the new location and thus move with the magnetic field peak.

FIG. 15 shows the traveling, in the direction of arrow 18, of the magnetic field cross-sectional profile 17, at different instances of time (t₁, t₂, t₃ . . . t₉), corresponding to the movement illustrated in FIG. 14. The magnetic field cross-sectional profile 17, as shown in FIG. 16, moves continuously across the matrix as the current magnitudes of currents, i_{y1} through i_{y7} and iₓ₁ through iₓ₇, in the seven individually addressable microconductors 41 of microconductor set 40 and the seven individually addressable microconductors 51 of microconductor set 50, respectively, are individually adjusted

It is noted that the trajectory resolution of the micro-electromagnetic matrix 35 is substantially governed by the number of microconductors in each array; the width of the microconductors; and the position of the magnetic field peak. More specifically, as the number of microconductors in the matrix is increased, the shape of magnetic field peak becomes more Gaussian in shape and the resolution of the magnetic field increases.

For example, for a micro-electromagnetic matrix configuration in which the microconductor width is the same as the microconductor spacing, the resolution of the magnetic peak is about 1/10 of microconductor width with 10×10 microconductor matrix. Above a microconductor, a loss of resolution can be expected due to peak broadening. On this peak position, the resolution is about ⅕ of the microconductor width. As the number of array microconductors in the matrix is increased, the shape of magnetic field peak becomes more Gaussian in shape and the resolution of the field increases. As a general example, to achieve ⅕ resolution, at least 5 microconductors in each direction are required.

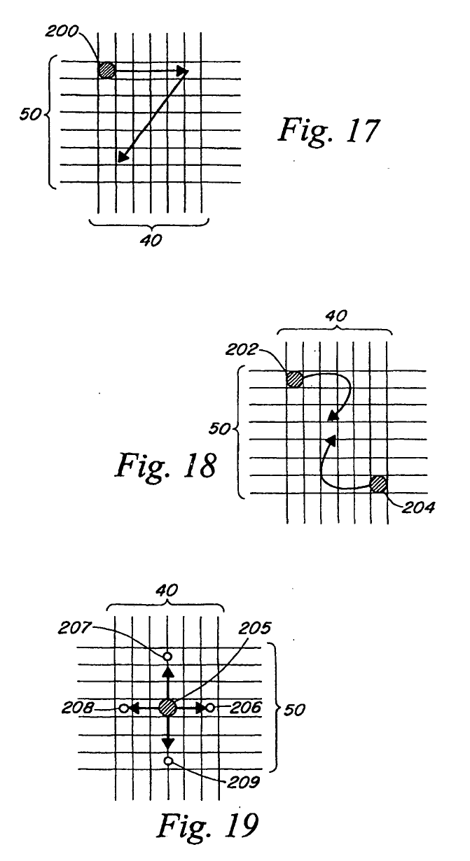

FIGS. 17 through 19 illustrate the versatility of the individual addressability of the microconductors of the micro-electromagnetic matrix. As shown in FIG. 17, a particle 200 can be moved in a line parallel to a set of microconductors 50 with nanoscale resolution or the particle can be moved in substantially all the directions of the compass with nanoscale resolution by adjusting the currents or voltages on the individually addressable microconductors. As shown in FIG. 18, two particles 202 and 204 can be moved so as to converge upon each other at a defined location. The two particles 202 and 204 can be moved with nanoscale resolution simultaneously and independently of each other by adjusting the currents or voltages on the individually addressable microconductors. Further as shown in FIG. 19, a group of particles 205 can be split into four individual groups of particles 206, 207, 208, and 209.

The present invention also provides the ability to spin a particle. The spinning action is enabled with a rotating magnetic field, which can be produced when two microconductors 41 and 51, as shown in FIG. 21, carry alternating currents that are 90 degrees out of phase. The magnitude of the field is a maximum where the two microconductors 41 and 51 cross, acting as a pivot point. The direction of the magnetic field rotates at a frequency f. Particles with a permanent magnetic moment are sensitive to the directional field and pivot around the cross pivot point. The maximum attainable frequency f depends on the friction between the particle and the surface and the viscosity of the fluid in which the particle is provided.

In addition to providing a means for trapping and movement, localized electromagnetic fields can be generated by micro-electromagnet matrix of the present invention to perturb and sense the response of particles. Two examples are nuclear magnetic resonance (NMR) and electron spin resonance (ESR).

Due to the micro-electromagnets' small size and geometry, micro-electromagnets are able to generate AC magnetic fields at RF and microwave frequencies in a small volume containing a single particle or group of particles so that the response of the magnetization inside the particle can be tested. FIG. 13 illustrates a specific example of a microelectrode matrix according to the concepts of the present invention. As shown in FIG. 13, a microelectrode matrix 60 comprises a plurality of microelectrodes 61 formed on a substrate 22. An insulating layer 62 covers the microelectrodes 61. The microelectrode matrix 60 is used to manipulate non-magnetic particles. On the substrate 22, the array of microelectrodes 61 can be patterned using either optical lithography, or electron beam lithography, and metal deposition. The insulating layer 62 is fabricated on top to prevent electric shorting of the device.

The microelectrode matrix 60 is an array of conducting electrodes with an insulating layer on top. By generating a single electric field peak or multiple independent electric field peaks that interact with the particles induced dipole moments, the microelectrode matrix 60 can manipulate neutral particles suspended in fluid. The potentials in each microelectrode 61 can be adjusted to produce desired electric field peak(s). The microelectrode matrix 60 is the ‘dual’ version of the micro-electromagnet matrix 35 described above, which uses an array of current-carrying microconductors to generate a single or multiple magnetic field peaks. This duality of the microelectrode and micro-electromagnet matrix comes from the symmetry of Maxwell's equations.

Any particles with permanent electric dipole moments (ferroelectric particles); for example, KHPO₄, BaTiO₃, and PbTiO₃; can be manipulated using the microelectrodes 61 of the present invention. Moreover, the electric field peaks produced by microelectrodes 61 can induce dipole moments in neutral objects, enabling the micromanipulation of these objects including semiconductor crystals, micron-size plastic spheres, and biological cells. The force on particles with induced dipole moments is proportional to the spatial gradient of the magnitude of the electric field. Moreover, since the microelectrode matrix 60 of the present invention doesn't consume electric power, relatively high voltages can be applied to each microelectrode, resulting in high electric fields in microscopically confined regions. This allows precise control of neutral particles at room temperature.

In one embodiment, the microelectrode matrix 60 consists of twenty-five microelectrodes with a diameter less than 50 μm and a preferred diameter of 2μm and a preferred height of 5 μm. The microelectrodes 61 are equally spaced with a preferred center-to-center distance of less than 100 μm and a preferred center-to-center distance of 8 μm. On top of the microelectrodes 61, an insulating layer with a preferred thickness of 51 μm is placed. The electric fields produced by the microelectrodes 61 are a Gaussian shape peak in the electric field magnitude. By using the microelectrode matrix 60, the present invention can move a single electric field peak continuously within the matrix with a spatial resolution less than the microelectrode 61 spacing.

As for the micro-electromagnet matrix 35 and the microelectrode matrix 60, the spatial resolution of the peak positions and the shape of the peak can be improved by increasing the number of field sources (microconductors) or microelectrodes. Moreover, multiple peaks can be generated and controlled independently by changing potentials in the microelectrodes 61 or the currents in or potentials on the microconductors of the micro-electromagnet matrix 35.

The microelectrode matrix 60 of the present invention can have various applications both in physics and in biology because most interesting objects in those fields are polarizable with an external electric field. The microelectrode matrix 60 of the present invention can be used for precise positioning of these particles to study motion and characteristics, as well as for time-dependant excitation.

The devices of the present invention, micro-electromagnets, can be fabricated using lithography and other conventional semiconductor fabrication methods. Since the cooling of device is provided by heat conduction through the substrate, high thermal conductivity is preferred for the substrate for most applications. At room temperature, sapphire and silicon conduct well with thermal conductivities of 27 W/m·K and 148 W/m·K, respectively, compared to, for example, glass, having 1.4 W/m·K Sapphire or silicon is therefore preferred for most applications, although other substrate materials can be employed.

On a substrate, microconductor layers are patterned by lithography followed by metal deposition and lift-off process. Either optical lithography or electron-beam lithography can be used to cover a wide range of length scales. Electroplating patterned microconductor layers increases the cross-sectional area and permits large currents, which produce large magnetic fields. Metals such as Cu and Ag can be employed, but the best results are obtained with Au, for which current densities up to 10⁸ A/cm² can be achieved.

Insulating layers with good mechanical and electrical properties are fabricated on top of the microconductor layer to prevent electrical shorting between conductors and between conductors and magnetic particles. As an insulating layer with thickness greater than 1 μm, a photosensitive polyimide (PI series from HD Microsystems, Wilmington, Del. 19880) can be spun on top of the microconductor layer. For a thinner insulating layer, it is preferred to evaporate a thin layer of SiO₂ or Al₂O₃ over a microconductor layer.

Preferably the insulator thickness is comparable to and slightly less than the lateral or horizontal microconductor-microconductor spacing of the matrix. As with the substrate selection considerations, it is preferred that the insulator be provided as a transparent material for applications in which transmitted-light microscopy is employed for viewing matrix operations.

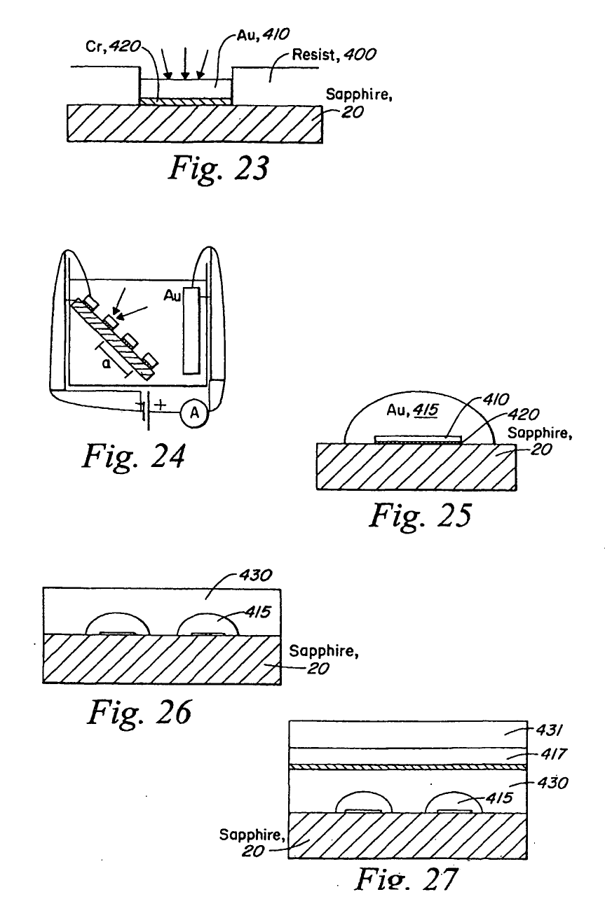

FIGS. 23 through 27 illustrate one example of fabricating the micro-electromagnet matrix of the present invention. As shown in FIG. 23, on a substrate 20, a Cr layer 420 and an Au layer 410 were patterned by optical or electron beam lithography by utilizing a resist material 400. The resistance of the conductor 410 is approximately 5 kΩ After dissolving the resist, the device is placed, as shown in FIG. 24, into an electroplating bath to grow an additional Au layer 415 upon the Au layer 410 and substrate 20 to produce the microconductor, as shown in FIG. 25. The resistance of the microconductor formed by Au layer 415 is approximately 10 Ω Thereafter, as shown in FIG. 26, an insulating layer 430 is formed over the Au layer 415 and substrate 20. The processes of FIGS. 23 through 26 are repeated to form a second Au layer or microconductor 417 and a second insulating layer 431, as illustrated in FIG. 27.

These structures are constructed on substrates by layers of lithographically patterned conductors separated by insulating layers. The ring trap is a single circular current-carrying microconductor with an insulating layer spun on top. The micro-electromagnet matrix consists of arrays of microconductors aligned non-parallel to each other, separated by an insulating layer, with an additional insulating layer spun on top. Patterned microconductor layers can be produced by optical lithography or by electron-beam lithography, covering a wide range of length scales. Electroplating patterned microconductor layers increases the cross-sectional area and permits large currents, which produce large magnetic fields. Insulating layers are used in multilayer structures to prevent electrical shorting between microconductors and between microconductors and magnetic particles.

Examples of two fabrication methods are provided below. The first example is a fabrication is done using optical lithography. The second example is a fabrication is done using electron beam lithography. Electron beam lithography may be preferred to enable dimensions too small to be produced by optical lithography

### EXAMPLE 1

1. Substrate cleaning (TCE, Acetone, and Methanol)

2. Photolithography (1^{st} microconductor conductor array pattern)

| | | | | |
|---|---|---|---|---|
| Spin Primer | 5000 | rpm | 40 | sec |
| Spin Photoresist 1813 | 5000 | rpm | 40 | sec |
| Bake(hot plate) substrate | 100° | C. | 3 | min 30 sec |
| UV exposure | 10 | mW/cm² | 6 | sec |
| Evaporate | Cr | | 100 | Å |
| | Au | | 800 | Å |

3. Plate with gold solution

Attach leads to the Au pattern in the substrate

Put the sample and electrode(Pt) in Au solution

Sample-cathode(−)

Pt plate-anode(+)

Apply current (0.1 mA) until the resistance of the pattern drops to 100 Ω

4. Photosensitive polyimide (1^{st} insulating layer)

| | | | | |
|---|---|---|---|---|
| Spin HD2729 | 6000 | rpm | 45 | sec |
| Soft bake(hot plate) | 60° | C. | 4 | min |
| | 80° | C. | 4 | min |
| | 100° | C. | 4 | min |
| Contact pads mask | | | | |
| UV exposure | 10 | mW//cm² | 1 | min |
| Develop in DE 6180 | 40 | s | | |
| Rinse in RI 9180 | 20 | s | | |
| Blow dry | 20 | s | | |
| Thermal cure(hot plate) | 120° | C. | 30 | min |
| ramp up to 260° C. at 2° C./min, | 260° | C. | 30 | min. |
| ramp down to 20° C. at 2° C./min | | | | |

5. Photolithography (2^{nd} microconductor conductor array pattern, same steps as in step 2 above, aligned as desired)

6. Plate with gold solution(same as 3)

7. Apply indium on all pads

Cover the pads with indium

8. Photosensitive polyimide(2^{nd} insulating layer)

| | | | | |
|---|---|---|---|---|
| Spin | 500 | rpm | 5 | sec |
| | 2500 | rpm | 40 | sec |
| Soft bake(hot plate) | 60° | C. | 4 | min |
| | 80° | C. | 4 | min |
| | 100° | C. | 4 | min |
| Contact pads mask | | | | |
| UV exposure | 10 | mW//cm² | 1 | min |
| Develop in DE 6180 | 40 | s | | |
| Rinse in RI 9180 | 20 | s | | |
| Blow dry | 20 | s | | |
| Thermal cure(hot plate) | 120° | C. | 30 | min |
| ramp up to 260° C. at 2° C./min, | 260° | C. | 30 | min. |
| ramp down to 20° C. at 2° C./min | | | | |

9. Attach Wires

Connect wires (gauge #32) to the indium covered pads using indium

### EXAMPLE 2

1. Clean Silicon wafers: Ultrasonic 10 min. each in TCE, Acetone and Methanol and blow dry.

2. Spin PMMA (495K, 4%)

| | | |
|---|---|---|
| a. | 500 rpm | 5 sec |
| b. | 3000 rpm | 30 sec |

3. Softbake(on hot plate) 5 min at 180 C.

4. Spin PMMA (495K, 4%)

| | | |
|---|---|---|
| a. | 500 rpm | 5 sec |
| b. | 3000 rpm | 30 sec |

5. Softbake(on hot plate) 5 min at 180 C.

6. Spin PMMA (950K, 2%)

| | | |
|---|---|---|
| a. | 500 rpm | 5 sec |
| b. | 3000 rpm | 40 sec |

7. Softbake(on hot plate) 5 min at 180 C.

8. Write the patterns of the 1^{st} layer microconductor array using E-beam lithography

9. Develop the patterns using PMMA developer (1 min)

10. Evaporate Cr (10 nm) and Au (200 nm) using thermal evaporator.

11. Lift off: Removes unexposed parts.

12. Evaporate Al₃O₄ for 200 nm: acts as an insulator

13. Repeat 2-12: writing second layer of conductors and insulator

14. Attach the leads

The choice of substrate on which the matrix is fabricated preferably is made based on three major factors: thermal conductivity of the substrate, the type of microscope used for optical monitoring of matrix operations, and the matrix fabrication method.

As noted above, with respect to thermal conductivity, since cooling of the matrix device is for many applications most efficiently provided by heat conduction through the substrate, high thermal conductivity is preferred for the substrate for most applications. At room temperature, sapphire and silicon conduct well with thermal conductivities of 27 W/m·K and 148 W/m·K, respectively, compared to, for example, glass, having 1.4 W/m·K. Sapphire or silicon is therefore preferred for most applications, although other substrate materials can be employed.

With respect to the type of microscope, for many applications, a microscope is preferably employed to monitor the matrix operations. In terms of the illumination method, microscopes generally fall in either of two categories, namely, transmitted light illumination and incident light illumination. A transmitted-light illumination microscope operates whereby the illuminating light comes through a sample and reaches an objective. This system, which can be preferred for observing transparent biological entities, requires the substrate to be transparent. When employing an incident-light microscope, transparent or opaque substrates can be used.

With respect to the fabrication method, when the substrate is an insulator, there can occur problematic electrical charging of the substrate by electron beam lithography processes. Therefore, silicon is the preferred substrate where electron beam lithography is to be employed. Where optical lithography is to be employed, either sapphire or silicon substrates, or other selected substrate, can be used.

| | | Available | | Fabrication | |
|---|---|---|---|---|---|
| | Thermal | Microscope | | method | |
| Substrate | Conductivity | Transmitted | Reflected | Optical | e-beam |
| Sapphire | Good | Yes | Yes | Yes | No |
| Silicon | Better | No | Yes | Yes | Yes |

Superconducting devices made of Nb were also fabricated to investigate the current carrying capabilities, but the current densities up to 2.5×10⁶ A/cm² were achieved at 4.2 K. The maximum current in superconductors is limited either by the critical field (type I) or by flux pinning (type II). Among existing materials, NB, NbTi, and Nb₃Sn could be used to obtain current densities up to 10⁷ A/cm², which is still lower than the values found for Au. Also, for applications where experiments are preferably performed at room temperature, normal metals are preferred to superconducting metals. The conductors can be provided as squared or rounded, as desired, or as resulting from a specific fabrication sequence. In general, rounded conductors are preferred for enabling production of a smooth magnetic field profile, but it is recognized that the fabrication process often dictates the conductor profile.

If a normal microconductor of width w on a planar substrate is carrying a current I, the condition to remove the ohmic heating via heat conduction through the substrate gives I/w<(kΔTₘₐₓ/r)½, where k is the thermal conductivity of the microconductor, r is the electrical resistivity and ΔTₘₐₓ is the maximum allowable temperature difference to the substrate. For Au matrix conductors at room temperature with ΔTₘₐₓ=100 K and standard values for k and r, I/w<10⁴ A/cm. Cooling can be used to achieve even higher values of I/w by reducing r and increasing k. It is thus found that adequate heat dissipation can be achieved through the matrix substrate.

At room temperature operations, under conditions whereby the microconductor current density can reach up to about 10⁷ A/cm², the resistance of the conductors is found to increase by 20-30%, which corresponds to a temperature increase of 50-70 K in the conductor microconductors. To accommodate and dissipate this temperature increase, it is preferred to provide the matrix substrate supported on a heat dissipation device, e.g., a thermoelectrically cooled stage, e.g., and preferably for many applications a peltier cooler, which generally can go down as low as −30 C. The heat generated due to the current can be dissipated through the substrate to the cooled stage. No particular cooling configuration is required, but for many applications, cooling is preferred through the substrate.

There is a close relationship between the preferred spacing between microconductors, the overall size of the matrix device, and the size of the particles to be manipulated. For materials such as cobalt and magnetite nanoparticles, quantum dot like particles such as CdSe, carbon nanotubes, or strings of DNA, the size scale of the particles is so small, that the spacing between the microconductors of an array of the matrix is preferably in the sub-micron scale, but the total size of the device can be micron scale. For materials such as cells or molecules, having a size range that is generally more than microns, the microconductor spacing can be comparable to the size of the materials. In this case, the total size of the matrix device can be as large as mm to cm depending on the application.

The particles to be manipulated by the matrix of the present invention can be provided at the location of the matrix in a fluid suspension. The present invention contemplates the use of generally any suitable fluid. In many cases, a suitable fluid is water. Preferably, the aggregation of particles in the selected fluid is substantially inhibited. In addition, it is preferred that the selected fluid be sufficiently non-volatile that significant evaporation does not occur during the manipulation application due to ohmic heating. For most applications, this evaporation consideration is easily met.

As noted above, a ring shaped micro-electromagnet produces a single trap for magnetic particles. A matrix configuration produces any number of magnetic field peaks, which each can trap particles at their positions. The matrix further enables the production of continuously moving peaks that enable the transport of particles to any location, and the production of multiple peaks that can be brought into a single peak to enable convergence of particles. In other embodiments, as explained above, two perpendicularly stacked microconductors can produce a rotating magnetic field, which can rotate particles. Alternating currents with 90 degrees out of phase are supplied to two microconductors. Additionally, two serpentine pattern microconductor configurations can be employed to form pockets of traps that can trap many particles at many locations at a time. This array of particles can be used for, e.g., drug testing on cells or large molecules—micron scale. With these various configurations, bioanalysis and processing, cell separation, immunoassay, and chemical manipulation and compound building are enabled.

Any particles with magnetic moments can be controlled utilizing currents in the micro-electromagnet matrix. Examples of these particles are ferromagnetic particle, iron powder, ferromagnetic particle, magnetite (200 nm inside magnetotactic bacteria), superparamagnetic particle, and magnetite in polymer encapsulation. With a fine-resolution version of the micro-electromagnet matrix, individual manipulation of Co nanoparticles(˜10 nm) is enabled.

It is noted that magnetic particles coated with selected functional chemicals or proteins can form strong bonds with corresponding counterparts. With this technique, non-magnetic entities can be controlled as well. Following are provided the examples of possible combinations: magnetic particle/quantum dot combination, any protein attached to magnetic particle (streptavidine), or magnetic particle/DNA conjugation. One can also coat magnetic particles with a cell-selective antibody to separate and manipulate a specific cell.

For example, magnetic particles may have their surfaces chemically functionalized by standard methods in order to conjugate them to proteins, oligonucleotides, biological cells, etc. A biological cell may be manipulated by the means provided by the present invention by conjugating it to a magnetic particle by, for example, an antibody specific to the cell may be conjugated to the particle, or the particle(s) may be inserted inside the cell. Such cells may now be manipulated for research purposes such as exposing them to drug candidates, or bringing two different cell types close together in a controllable manner to observe any outcome. An enzyme, which may be a druggable target, may be conjugated to a magnetic particle and controllably exposed to drug candidates. Different oligonucleotides conjugated to different magnetic particles may be used, with the matrices of the invention, analogously to genechips to detect binding partners in a sample.

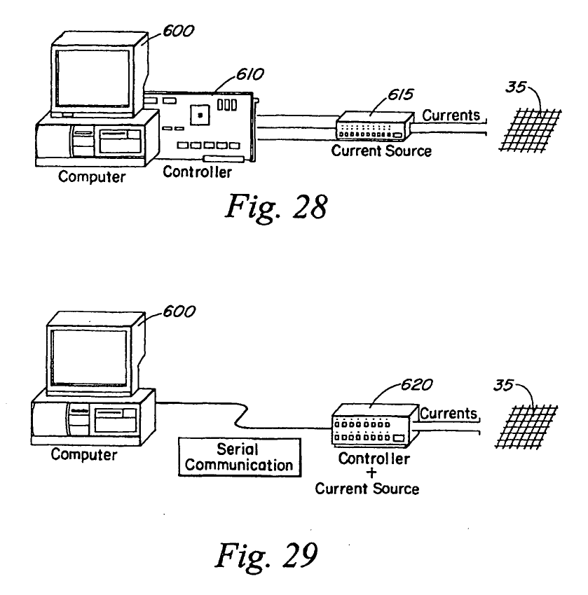

FIG. 28 illustrates a particle manipulation system utilizing the concepts of the present invention. In this embodiment, as illustrated in FIG. 28, a computer 600 is used to control the currents or voltages being supplied to each individually addressable microconductor in the micro-electromagnet matrix 35. The computer feeds information to a specifically designed controller 610 that produces control voltages. The controller 610 is connected to a current or voltage source 615, which outputs currents or voltages that are proportional to the received control voltages. Current or voltage source 615 is capable, in response to control voltages from the controller 610, of generating independent currents or voltages for each of the microconductors of the micro-electromagnet matrix 35. Software with graphical user interface that calculates appropriate current or voltage distribution for a selected particle trapping or transport scenario and sets the controller 610 to produce corresponding controlling voltages is also included in the computer 600. It is noted that the source 615 may include both current sources and voltages sources so that the micro-electromagnet matrix 35 can utilize either source depending upon the nature (magnetic or non-magnetic) of the particle being trapped or moved.

FIG. 29 illustrates another particle manipulation system utilizing the concepts of the present invention. In this embodiment, as illustrated in FIG. 29, a computer 600 is used to control the currents being supplied to each individually addressable microconductor in the micro-electromagnet matrix 35. The computer feeds information to a controller/current or voltage source 620, which outputs currents or voltages. Controller/current or voltage source 620 is capable, in response to control signals from the computer 600, of generating independent currents or voltages for each of the microconductors of the micro-electromagnet matrix 35. Software with graphical user interface that calculates appropriate current or voltage distribution for a selected particle trapping or transport scenario and sets the controller/current or voltage source 620 to produce corresponding currents or voltages is also included in the computer 600. It is noted that the controller/source 620 may include both current sources and voltages sources so that the micro-electromagnet matrix 35 can utilize either source depending upon the nature (magnetic or non-magnetic) of the particle being trapped or moved.

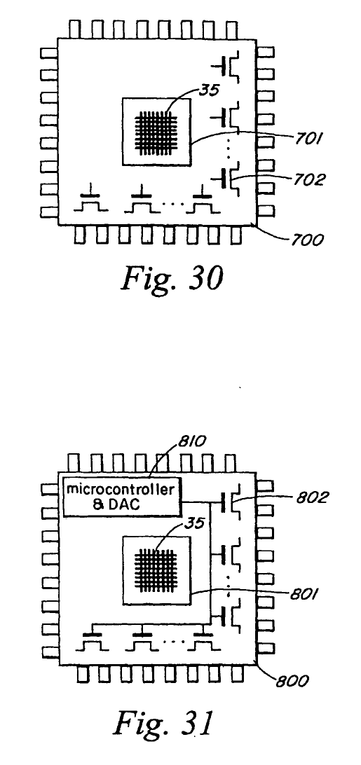

FIG. 30 shows an implementation of the micro-electromagnet matrix, microelectrode matrix, or a micro-electromagnet array on an integrated circuit chip. As the size of the micro-electromagnet matrix, microelectrode matrix, or micro-electromagnet array is reduced, current or voltage sources can be embedded in the substrate such that the whole device is self-contained. In this scenario, the controlling voltages are sent on-chip for on-chip production of currents or voltages to produce a desired field. More specifically, as shown in FIG. 30, the integrated circuit chip 700, includes a plurality of sources 702, one for each microconductor, to control the current or voltage on the microconductors of the micro-electromagnet matrix 35 in response to received voltages from a controller. The integrated circuit chip 700 further includes an access window 701 around the micro-electromagnet matrix 35 to enable operations with a transmitted-light illumination microscope. It is noted that the micro-electromagnet matrix 35 may be interchanged with a microelectrode matrix or a micro-electromagnet array. It is further noted that the plurality of sources 702 may included both current sources and voltage source so that the integrated circuit chip 700 can utilize either source depending upon the nature (magnetic or non-magnetic) of the particle being trapped or moved.

FIG. 31 shows another implementation of the micro-electromagnet matrix, microelectrode matrix, or a micro-electromagnet array on an integrated circuit chip. In this scenario, the controlling unit sends commands on-chip for on-chip interpretation by the microcontroller 810 to control the production of currents or voltages to produce a desired field. More specifically, as shown in FIG. 31, the integrated circuit chip 800, includes a plurality of sources 802, one for each microconductor, connected to the microcontroller 810 to generate the current or voltage on the microconductors of the micro-electromagnet matrix 35 in response to received signals from the microcontroller 810. The integrated circuit chip 800 further includes an access window 801 around the micro-electromagnet matrix 35 to enable operations with a transmitted-light illumination microscope. It is noted that the micro-electromagnet matrix 35 may be interchanged with a microelectrode matrix or a micro-electromagnet array. It is further noted that the plurality of sources 802 may included both current sources and voltage source so that the integrated circuit chip 800 can utilize either source depending upon the nature (magnetic or non-magnetic) of the particle being trapped or moved.

The micro-electromagnet matrix of the present invention can trap, move, separate, join and rotate magnetic particles with microscopic or nanoscale resolution, with achievable resolution to ˜100 nm. The micro-electromagnet matrix of the present invention consists of multiple layers of lithographically defined Au microconductors separated by transparent, insulating layers on substrates. High magnetic fields (B˜0.1 T) and high field gradients (∇B˜10⁴ T/m) produced by the micro-electromagnet matrix allow precise control of magnetic particles in fluids at room temperature. Any magnetic particles can be manipulated including ferromagnetic or superparamagnetic nanoparticles, magnetotactic bacteria, and magnetically tagged cells and DNA.

As noted above, the magnetic field produced by the current carrying microconductors attracts magnetic particles to local maximum in the field magnitude. Magnetic dipole interaction between the magnetic fields produced by the microconductors and the particle's magnetic moment allows the particles to move to desired locations. Since the micro-electromagnet matrix of the present invention produces sharp magnetic field peaks in microscopic region, individual control of magnetic particles is possible. Therefore, using the micro-electromagnet matrix of the present invention, magnetic particles can be trapped and assembled at desired locations and biological systems can be captured at different locations and brought in together to study their interactions.

The micro-electromagnet matrix of the present invention can be used to assemble custom designed structures by trapping and moving magnetic particles in continuous motion by increments less than the microconductor spacing.

Moreover, magnetotactic bacteria can be trapped in one position and continuously moved down to another by changing current distribution on the micro-electromagnet matrix of the present invention. Without damaging the magnetotactic bacteria, the present invention can freely change the location of these bacteria by changing the currents on a matrix using a computer. Cells and DNA attached to magnetic particles can also be controlled using micro-electromagnets of the present invention.

As noted before, the micro-electromagnet matrix of the present invention has several advantages over other present technologies for micromanipulations, which enable the wide use of the device not only in research communities but also in commercial, industrial communities. Since the micro-electromagnet matrix is fabricated using contemporary semiconductor fabrication technique (optical lithography), immediate mass production of the device is feasible without modifying current production lines, which makes the device available at low cost. The micro-electromagnet matrix of the present invention doesn't require external magnetic fields for its operations.

Furthermore, by embedding current sources and controlling units in the same chip using VLSI manufacturing techniques, the whole device can shrink down to less than 1 cm×1 cm. In addition, the device can be easily integrated with any optical microscopes, enabling simultaneous control and observation of samples in real time. The micro-electromagnet matrix of the present invention can generate magnetic fields strong enough to manipulate samples suspended in fluids at room temperature, making the whole manipulation possible at ambient conditions. The device also can be controlled through a user-friendly computer interface. Thus, with minimal training, one can micromanipulate various nano-objects easily.

In using the present invention, complex static and dynamic magnetic field profiles can be created by adjusting current distributions. Any number of peaks in magnetic field magnitude can be produced simultaneously at any position on the surface of the device. Furthermore, these peaks can be moved with nanoscale spatial resolutions and controlled independently. This flexibility and versatility of the micro-electromagnet matrix of the present invention provides a new way of assembling nano-objects into custom-made structures.

There are enormous potentials for the micro-electromagnet matrix to be used in various fields of research and commercial areas. For example, nanocircuits of different nanoparticles, such as semiconductor nanocrystals, metallic nanoparticles, or various nanowires, can be constructed by linking magnetic nanoparticles to non-magnetic nano-objects, moving and assembling these particles. Nanowires may be magnetic or paramagnetic because of their composition or may be magnetic because they were grown on a magnetic nanoparticle catalyst such as an iron nanoparticle and are still attached to the magnetic nanoparticle.

Controlled experiments with biological systems including cells, microorganisms, DNAs, and proteins can be carried out by inserting or attaching magnetic particles to those entities. Furthermore, the whole experiments can be automated and miniaturized, realizing “micro-Total Analysis systems” μTAS) on a single chip. Noteworthy is the capability of micro-electromagnets in simultaneous micromanipulation of biological systems as well as a variety of inorganic nanoparticles with quantum characteristics. This can open the possibilities of constructing hybrid nanocircuits utilizing both electronic properties of nanoparticles and molecular-scale sensitivities of biological systems.

The micro-electromagnet matrix of the present invention is particularly elegant due to its completeness. It is not possible to configure and control magnetic field maxima to control particles at will employing only one layer of conductors. But in accordance with the present invention, with two layers of microconductor arrays, the matrix is a complete device: there is no need for an external field and any magnetic field configuration can be produced, due to the principal of superposition. Additional layers of conductors are therefore not needed for production of a desired magnetic field pattern, but can be included if desired for a given application. Similarly, the layers of microconductors can be provided orthogonal to each other or at some non-orthogonal orientation. For most applications, an orthogonal orientation is preferred to enable symmetry across the arrays. Due to superposition, any field pattern can be produced by the orthogonal array. Such may not be the case for non-orthogonal array orientations.

Each microconductor in each conductor array of the micro-electromagnet matrix of the present invention can be controlled at a distinct current level and further at a distinct operational frequency, e.g., up to the microwave frequency range. This ability to employ distinct current levels and frequencies enables the production of a wide range of the field configurations with only two layers of conductors.

The present invention contemplates the provision of various electrical devices built and integrated on top of the micro-electromagnet matrix of the present invention. For example, various configurations of conductors can be provided on top of the upper insulating layer of the micro-electromagnet matrix of the present invention, e.g., for sensing, testing, or collecting particles. Thus, various experiments using these upper test conductors can be carried out, with the lower micro-electromagnet matrix conductors controlling the particles' locations.

Moreover, the present invention is a versatile device, which can create complex static or dynamic magnetic field profiles for many experimental purposes.

Using a the micro-electromagnet matrix of the present invention, trapping of particles at a desired location, the continuous motion of particles in two dimensions, and the simultaneous motion and joining of two separate groups of particles into one group can be easily realized. The micro-electromagnet matrix of the present invention can also rotate magnetic particles above a fixed position utilizing time dependent current control. To control and manipulate semiconductor nanocrystals, micro-electromagnets or microelectrode arrays could produce electric field peaks that interact with the particle's induced electric dipole moment.

While various examples and embodiments of the present invention have been shown and described, it will be appreciated by those skilled in the art that the spirit and scope of the present invention are not limited to the specific description and drawings herein, but extend to various modifications and changes all as set forth in the following claims.

What is claimed is:

1. A microstructure system for capturing and positioning magnetic particles, comprising:
a substrate layer;
a first set of microconductors formed upon said substrate layer;
a first insulating layer formed upon said first set of microconductors;
a second set of microconductors formed upon said first insulating layer; and
a current generator circuit, having a plurality of individually controllable current sources, to generate an independent variable current in each microconductor from said first and second set of microconductors so as to generate a peak in its magnitude, with the location of the magnetic field peak being established with nanoscale resolution.

2. The microstructure system as claimed in claim 1, wherein said microconductors are transparent.

3. The microstructure system as claimed in claim 1, wherein said microconductors of said first set of microconductors are parallel to each other.

4. The microstructure system as claimed in claim 1, wherein said microconductors of said second set of microconductors are parallel to each other.

5. The microstructure system as claimed in claim 1, wherein each microconductor of said second set of microconductors forms a substantial orthogonal angle with each microconductor of said first set of microconductors.

6. The microstructure system as claimed in claim 1, wherein said current generator circuit generates independent variable currents along said first and second set of microconductors so as to generate a dynamic magnetic field peak.

7. The microstructure system as claimed in claim 1, wherein said current generator circuit generates independent variable currents along said first and second set of microconductors so as to generate a dynamic location of the magnetic field peak.

8. The microstructure system as claimed in claim 1, wherein said current generator circuit changes the characteristics of the independent variable currents along said first and second set of microconductors so as to move the location of the magnetic field peak in a continuous manner.

9. The microstructure system as claimed in claim 1, wherein said current generator circuit generates direct currents along said first and second set of microconductors.

10. The microstructure system as claimed in claim 1, wherein said current generator circuit generates alternating currents along said first and second set of microconductors.

11. The microstructure system as claimed in claim 9, wherein said current generator circuit superimposes an alternating current upon the generated direct currents.

12. The microstructure system as claimed in claim 1, wherein said substrate layer is sapphire.

13. The microstructure system as claimed in claim 1, wherein said substrate layer is silicon.

14. The microstructure system as claimed in claim 1, wherein said microconductors are comprised of a metal.

15. The microstructure system as claimed in claim 1, further comprising:
a second insulating layer formed upon said second set of microconductors.

16. The microstructure system as claimed in claim 15, wherein said second insulating layer has a vertical thickness proportional to a horizontal spacing of the microconductors.

17. The microstructure system as claimed in claim 1, further comprising:
a micro-controller to control the generation of currents so as to vary a magnitude of the generated magnetic field peak and to vary a location of the generated magnetic field peak.

18. The microstructure system as claimed in claim 1, wherein a center-to-center center horizontal spacing between adjacent microconductors greater than or equal to 20 microns.

19. The microstructure system as claimed in claim 1, wherein a center-to-center horizontal spacing between adjacent microconductors is less than 20 microns.

20. The microstructure system as claimed in claim 1, wherein a width of a microconductor is less than 50 microns.

21. The microstructure system as claimed in claim 1, wherein the generated magnetic field has a peak magnitude greater than or equal to 20 Gauss.

22. The microstructure system as claimed in claim 1, wherein said current generator circuit generates variable currents along said first and second set of microconductors so as to generate a plurality of magnetic field peaks, a location of each magnetic field peak being established, independently, with nanoscale resolution.

23. A microstructure system for capturing and positioning magnetic particles, comprising:
a substrate layer;
a first serpentine-shaped microconductor formed upon said substrate layer;
a first insulating layer formed upon said first serpentine-shaped microconductor;
a second serpentine-shaped microconductor formed upon said first insulating layer; and
a current generator circuit to generate variable independent currents along said first and second serpentine-shaped microconductors so as to generate a magnetic field pattern having a plurality of magnetic field peaks.

24. The microstructure system as claimed in claim 23, wherein said first and second serpentine-shaped microconductors are transparent.

25. The microstructure system as claimed in claim 23, wherein said substrate layer is sapphire.

26. The microstructure system as claimed in claim 23, wherein said serpentine-shaped microconductors are comprised of Au.

27. The microstructure system as claimed in claim 23, further comprising:
a second insulating layer formed upon said second serpentine-shaped microconductor.

28. The microstructure system as claimed in claim 23, wherein a width of a serpentine-shaped microconductor is less than 50 microns.

29. The microstructure system as claimed in claim 23, wherein said current generator circuit changes the characteristics of the independent variable currents along said first and second serpentine-shaped microconductors so as to oscillate the location of the magnetic field peaks in the magnetic field pattern.

30. A microstructure system for capturing and positioning non-magnetic particles, comprising:
a substrate layer;
a matrix of microelectrodes formed upon said substrate layer;
an insulating layer formed upon said matrix of microelectrodes; and
a voltage generator circuit, having a plurality of individually controllable voltage sources, to generate an independent variable voltage in each microelectrode so as to generate a peak in its magnitude, with the location of the electric field peak being established with nanoscale resolution.

31. The microstructure system as claimed in claim 30, wherein said microelectrodes are transparent.

32. The microstructure system as claimed in claim 30, wherein said substrate layer is sapphire.

33. The microstructure system as claimed in claim 30, further comprising:
a micro-controller to control the generation of voltages so as to vary a magnitude of a generated electric field peak and to vary a location of the generated electric field peak.

34. The microstructure system as claimed in claim 30, wherein a diameter of a microelectrode is less than 50 microns.

35. The microstructure system as claimed in claim 30, wherein a center-to-center spacing between adjacent microelectrodes is less than 100 microns.

36. The microstructure system as claimed in claim 30, wherein a height of a microconductor is 5 microns.

37. The microstructure system as claimed in claim 30, wherein said voltage generator circuit changes the characteristics of the independent variable voltages at each microelectrode so as to move the location of an electric field peak in a continuous manner.

38. A method for capturing and positioning magnetic particles, comprising:
(a) providing a fluid upon a surface having magnetic particles therein;
(b) generating a plurality of independent magnetic field peaks;
(c) capturing a magnetic particle with one of the generated magnetic field peaks; and
(d) changing a location of one of the magnetic field peaks to move the captured magnetic particle with nanoscale resolution.

39. The method as claimed in claim 38, wherein the plurality of magnetic field peaks is generated by applying an independent electrical current to each microconductor making up a matrix of microconductors.

40. The method as claimed in claim 38, wherein said (d) changes substantially simultaneously a location of one magnetic field peak independently of changing a location of another magnetic field peak to move two captured magnetic particles, independent of each other, with nanoscale resolution.

41. The method as claimed in claim 39, wherein direct currents are applied to the microconductors so as to generate the plurality of magnetic field peaks.

42. The method as claimed in claim 39, wherein the characteristics of the independent variable currents are changed so as to move the location of a magnetic field peak in a continuous manner.

43. The method as claimed in claim 39, further comprising:
(e) probing the captured magnetic particle by applying an alternating current to select microconductors.

44. The method as claimed in claim 39, further comprising:
(e) detecting the captured magnetic particle by applying an alternating current to select microconductors.

45. The method as claimed in claim 39, further comprising:
(e) applying an alternating current to select microconductors so as to magnetic resonance image the captured magnetic particle.

46. The method as claimed in claim 41, wherein an alternating current is superimposed upon the generated direct currents.

47. A method for capturing and positioning particles, comprising:
(a) providing a fluid upon a surface having particles therein;
(b) generating a plurality of independent electric field peaks;
(c) capturing a particle with one of the generated electric field peaks; and
(d) changing a location of one of the electric field peaks to move the captured particle with nanoscale resolution.

48. The method as claimed in claim 47, wherein the plurality of independent electric field peaks is generated by applying an independent voltage to each microelectrode of a matrix of microelectrodes.

49. The method as claimed in claim 48, wherein the characteristics of the independent variable voltages at each microelectrode change so as to move a location of the electric field peak in a continuous manner.

50. A method for capturing and positioning multiple sets of magnetic particles, comprising:
(a) providing a fluid upon a surface having magnetic particles therein;
(b) generating a plurality of independent magnetic field peaks;
(c) capturing a plurality of magnetic particles with each of the generated independent magnetic field peaks; and
(d) changing, substantially simultaneously, locations of the plurality of independent magnetic field peaks to move, independently, a plurality of the captured set of magnetic particles with nanoscale resolution.

51. The method as claimed in claim 50, wherein the plurality of independent magnetic field peaks are generated by applying an independent electrical current to each microconductor making up a matrix of microconductors.

52. The method as claimed in claim 51, wherein the characteristics of the independent electrical currents are changed so as to move the location of a magnetic field peak in a continuous manner.

53. A method for capturing and positioning multiple sets of particles, comprising:
(a) providing a fluid upon a surface having particles therein;
(b) generating a plurality of independent electric field peaks;
(c) capturing a plurality of particles with each of the generated independent electric field peaks; and
(d) changing, substantially simultaneously, locations of the plurality of independent electric field peaks to move independently, a plurality of the captured set of particles with nanoscale resolution.

54. A system for capturing and positioning multiple sets of magnetic particles, comprising:
a micro-electromagnetic matrix having a plurality of individually addressable microconductors; and
a plurality of controllable current sources, each individually addressable microconductor having a controllable current source associated therewith, each controllable current source providing a current to the associated individually addressable microconductor to generate a magnetic field peak, said magnetic field peak having a location that can be moved continuously.

55. The system as claimed in claim 54, wherein each controllable current source providing a current to the associated individually addressable microconductor to move the magnetic field peak location with nanoscale resolution.

56. A system for capturing and positioning multiple sets of particles, comprising:
a microelectrode matrix having a plurality of individually addressable electrodes; and
a plurality of controllable voltages sources, each individually addressable electrode having a controllable voltage source associated therewith, each controllable voltage source providing a voltage to the associated individually addressable microelectrode to generate an electric field peak, said electric field peak having a location that can be moved continuously.

57. The system as claimed in claim 55, wherein each controllable voltage source providing a voltage to the associated individually addressable microelectrode to move the electric field peak location with nanoscale resolution.

58. An integrated circuit for capturing and positioning magnetic particles, comprising:
an access window;
a plurality of individually addressable microconductors located in said access window, said plurality of individually addressable microconductors having different directions and forming in a matrix; and
a micro-controller to control an amount of current being applied to each of the individually addressable microconductors.

59. The integrated circuit as claimed in claim 58, wherein said plurality of individually addressable microconductors comprises:
a first set of microconductors;
a first insulating layer formed upon said first set of microconductors;
a second set of microconductors formed upon said first insulating layer.

60. The integrated circuit as claimed in claim 58, further comprising:
a plurality of controllable current sources, each individually addressable microconductor having a controllable current source associated therewith such that the controllable current sources provide the currents necessary to generate a magnetic field peak.

61. The integrated circuit as claimed in claim 60, wherein each controllable current source provides a current to the associated individually addressable microconductor to move a location of the magnetic field peak with nanoscale resolution.

62. The integrated circuit as claimed in claim 60, wherein each controllable current source provides a varying current to the associated individually addressable microconductor to move a location of the magnetic field peak in a continuous manner.

63. An integrated circuit for capturing and positioning particles, comprising:
an access window;
a plurality of individually addressable microelectrodes located in said access window, said plurality of individually addressable microelectrodes forming in a matrix; and
a micro-controller to control an amount of voltage being applied to each of the individually addressable microelectrodes.

64. The integrated circuit as claimed in claim 63, further comprising:
a plurality of controllable voltages sources, each individually addressable microelectrode having a controllable voltage source associated therewith such that the controllable voltage sources provide the voltages necessary to generate an electric field peak.

65. The integrated circuit as claimed in claim 64, wherein each controllable voltage source provides a voltage to the associated individually addressable microelectrode to move a location of the electric field peak with nanoscale resolution.

66. The integrated circuit as claimed in claim 64, wherein each controllable voltage source provides a varying voltage to the associated individually addressable microelectrode to move a location of the electric field peak in a continuous manner.

67. A microstructure system for capturing and positioning magnetic particles, comprising:
a substrate layer;
a plurality of layers of microconductors formed upon said substrate layer;
a plurality of insulating layers, an insulating layer being formed between each layer of microconductors; and
a current generator circuit, having a plurality of individually controllable current sources, to generate an independent variable current in each microconductor so as to generate a magnetic field having a peak in its magnitude, with the location of the magnetic field peak being established with nanoscale resolution.

68. The microstructure system as claimed in claim 67, wherein said current generator circuit changes the characteristics of the independent variable currents along said microconductors so as to move the location of the magnetic field peak in a continuous manner.

69. The microstructure system as claimed in claim 66, wherein said current generator circuit generates direct currents along said microconductors.

70. The microstructure system as claimed in claim 67, wherein said current generator circuit generates alternating currents along said microconductors.

71. The microstructure system as claimed in claim 69, wherein said current generator circuit superimposes an alternating current upon the generated direct currents.

72. The microstructure system as claimed in claim 67, wherein said current generator circuit generates variable currents along said microconductors so as to generate a plurality of magnetic field peaks, a location of each magnetic field peak being established, independently, with nanoscale resolution.

73. A microstructure system for applying radio frequency or microwave fields to a particle, comprising:
a substrate layer;
a plurality of layers of microconductors formed upon said substrate layer;
a plurality of insulating layers, an insulating layer being formed between each layer of microconductors; and
a generator circuit, having a plurality of individually controllable sources, to generate an independent alternating current in each microconductor so as to generate a radio frequency or microwave electromagnetic field at the position of a particle.

74. A microstructure system for capturing and positioning particles, comprising:
a substrate layer;
a first set of microconductors formed upon said substrate layer;
a first insulating layer formed upon said first set of microconductors;
a second set of microconductors formed upon said first insulating layer; and
a voltage generator circuit, having a plurality of individually controllable voltage sources, to generate an independent variable voltage on each microconductor to ground from said first and second set of microconductors so as to generate a peak in its magnitude, with the location of the electric field peak being established with nanoscale resolution.

75. A microstructure system for capturing and positioning particles, comprising:
a substrate layer;
a first set of microconductors formed upon said substrate layer;
a first insulating layer formed upon said first set of microconductors;
a second set of microconductors formed upon said first insulating layer;
a voltage generator circuit, having a plurality of individually controllable voltage sources, to generate an independent variable voltage on each microconductor to ground from said first and second set of microconductors so as to generate a peak in its magnitude, with the location of the electric field peak being established with nanoscale resolution; and
a current generator circuit, having a plurality of individually controllable current sources, to generate an independent variable current in each microconductor from said first and second set of microconductors so as to generate a peak in its magnitude, with the location of the magnetic field peak being established with nanoscale resolution.

76. A microstructure system for capturing and positioning particles, comprising:
a substrate layer;
a first serpentine-shaped microconductor formed upon said substrate layer;
a first insulating layer formed upon said first serpentine-shaped microconductor;
a second serpentine-shaped microconductor formed upon said first insulating layer; and
a voltage generator circuit to generate variable independent voltages on said first and second serpentine-shaped microconductors so as to generate an electric field pattern having a plurality of electric field peaks.

77. A microstructure system for capturing and positioning particles, comprising:
a substrate layer;
a first serpentine-shaped microconductor formed upon said substrate layer;
a first insulating layer formed upon said first serpentine-shaped microconductor;
a second serpentine-shaped microconductor formed upon said first insulating layer;
a voltage generator circuit to generate variable independent voltages on said first and second serpentine-shaped microconductors so as to generate an electric field pattern having a plurality of electric field peaks; and
a current generator circuit to generate variable independent currents along said first and second serpentine-shaped microconductors so as to generate a magnetic field pattern having a plurality of magnetic field peaks.

78. A system for capturing and positioning multiple sets of particles, comprising:
a micro-electromagnetic matrix having a plurality of individually addressable microconductors; and
a plurality of controllable voltage sources, each individually addressable microconductor having a controllable voltage source associated therewith, each controllable voltage source providing a voltage to the associated individually addressable microconductor to generate an electric field peak, said electric field peak having a location that can be moved continuously.

79. A system for capturing and positioning multiple sets of particles, comprising:
a micro-electromagnetic matrix having a plurality of individually addressable microconductors; and
a plurality of controllable current sources, each individually addressable microconductor having a controllable current source associated therewith, each controllable current source providing a current to the associated individually addressable microconductor to generate a magnetic field peak, said magnetic field peak having a location that can be moved continuously; and
a plurality of controllable voltage sources, each individually addressable microconductor having a controllable voltage source associated therewith, each controllable voltage source providing a voltage to the associated individually addressable microconductor to generate an electric field peak, said electric field peak having a location that can be moved continuously.

80. An integrated circuit for capturing and positioning particles, comprising:
an access window;
a plurality of individually addressable microconductors located in said access window, said plurality of individually addressable microconductors having different directions and forming in a matrix;
a plurality of controllable current sources, each individually addressable microconductor having a controllable current source associated therewith, each controllable current source providing a current to the associated individually addressable microconductor to generate a magnetic field peak, said magnetic field peak having a location that can be moved continuously; and
a plurality of controllable voltage sources, each individually addressable microconductor having a controllable voltage source associated therewith, each controllable voltage source providing a voltage to the associated individually addressable microconductor to generate an electric field peak, said electric field peak having a location that can be moved continuously.

81. An integrated circuit for capturing and positioning particles, comprising:
an access window;
a plurality of individually addressable microconductors located in said access window, said plurality of individually addressable microconductors having different directions and forming in a matrix; and
a plurality of controllable current sources, each individually addressable microconductor having a controllable current source associated therewith, each controllable current source providing a current to the associated individually addressable microconductor to generate a magnetic field peak, said magnetic field peak having a location that can be moved continuously.

82. An integrated circuit for capturing and positioning particles, comprising:
an access window;
a plurality of individually addressable microconductors located in said access window, said plurality of individually addressable microconductors having different directions and forming in a matrix; and
a plurality of controllable voltage sources, each individually addressable microconductor having a controllable voltage source associated therewith, each controllable voltage source providing a voltage to the associated individually addressable microconductor to generate an electric field peak, said electric field peak having a location that can be moved continuously.

83. An integrated circuit for capturing and positioning particles, comprising:
an access window;
a plurality of individually addressable microconductors located in said access window, said plurality of individually addressable microconductors having different directions and forming in a matrix; and
a micro-controller to control an amount of voltage being applied to each of the individually addressable microconductors.

84. An integrated circuit for capturing and positioning particles, comprising:
an access window;
a plurality of individually addressable microconductors located in said access window, said plurality of individually addressable microconductors having different directions and forming in a matrix; and
a micro-controller to control an amount of current or voltage being applied to each of the individually addressable microconductors.

85. A microstructure system for capturing and positioning particles, comprising:
a substrate layer;
a plurality of layers of microconductors formed upon said substrate layer;
a plurality of insulating layers, an insulating layer being formed between each layer of microconductors; and
a voltage generator circuit, having a plurality of individually controllable voltage sources, to generate an independent variable voltage on each microconductor so as to generate an electric field having a peak in its magnitude, with the location of the electric field peak being established with nanoscale resolution.

86. A microstructure system for capturing and positioning particles, comprising:
a substrate layer;
a plurality of layers of microconductors formed upon said substrate layer;
a plurality of insulating layers, an insulating layer being formed between each layer of microconductors;
a current generator circuit, having a plurality of individually controllable current sources, to generate an independent variable current in each microconductor so as to generate a magnetic field having a peak in its magnitude, with the location of the magnetic field peak being established with nanoscale resolution; and
a voltage generator circuit, having a plurality of individually controllable voltage sources, to generate an independent variable voltage on each microconductor so as to generate an electric field having a peak in its magnitude, with the location of the electric field peak being established with nanoscale resolution.
